(19) United States
(12) Patent Application Publication
(10) Pub. No.: US 2026/0222040 A1
(43) Pub. Date: Jul. 30, 2026

(54) SYSTEMS AND METHODS FOR CSI FEEDBACK FRAMEWORK BASED ON AI

(71) Applicant: Mavenir Systems, Inc., Richardson, TX (US)

(72) Inventors: Yuanlong Yang, Beijing (CN); Fan Yang, Beijing (CN); Jianying Liu, Beijing (CN)

(73) Assignee: Mavenir Systems, Inc., Richardson, TX (US)

(21) Appl. No.: 19/575,064

(22) Filed: Mar. 23, 2026

Related U.S. Application Data
(63) Continuation of application No. PCT/CN2023/122783, filed on Sep. 28, 2023.

(51) Int. Cl. H04B 7/06

(52) U.S. Cl. CPC H04B 7/0626

(57) ABSTRACT

Systems and methods AI/ML based CSI Compression and Prediction.

### CROSS REFERENCE TO RELATED APPLICATIONS

This application is a continuation of U.S. patent application of International Application No. PCT/CN2023/122783, filed on Sep. 28, 2023, the entirety of which is incorporated herein by reference.

### BACKGROUND OF THE DISCLOSURE

### Field of the Disclosure

The present disclosure relates to systems and methods for radio access networks. The present disclosure is related to the design of operation, administration and management of various network elements of 4G and 5G based mobile networks. The present disclosure relates to CSI enhancements in mobile networks.

### Description of the Related Art

The CSI feedback of the 5G NR system did not adopt full channel feedback, due to the high cost of full channel feedback. If AI can greatly reduce the cost of feedback after compression, it is possible to perform AI based full channel feedback in 5G-A systems.

### SUMMARY

Described are systems and methods for CSI feedback through AI/ML, including an air interface enhancement of the CSI feedback with enabling AI/ML-based algorithms.

The disclosure provides one payload size determination in AI based CSI feedback. Embodiments of the disclosure include introducing a method to determine the payload size of AI based CSI feedback. Embodiments include using legacy CQI to evaluate the quality of obtained CSI on the UE side and adjust the payload size of AI model based on obtained CQI.

The disclosure also describes introducing two options of AI model information signaling between UE and base station. Option1: Information including the basic structure and main parameters of the AI model. Option2: AI model can be a “black box”, for example, an executable program.

Also disclosed are embodiments for taking a previous CSI correlation into consideration to decide whether to enable a AI based CSI prediction function. When CSI prediction function is enabled, the base station configures the UE with a prediction target of X milliseconds in the future (which can be subject to a UE capability) then the UE compresses the predicted CSI using one of the already available mechanisms. For instance, the UE can feedback PMI/RI/CQI information using, for example, e-Type II codebook. Alternatively, the UE can compress the raw CSI using an AI/ML CSI compression approach.

The present disclosure describes three cases for an AI based CSI feedback framework. Case1: AI based CSI compression is enabled, AI based CSI prediction is disabled. Case2: AI based CSI compression is enabled, AI based CSI prediction is enabled. Case3: AI based CSI compression is disabled, AI based CSI prediction is disabled.

### BRIEF DESCRIPTION OF THE DRAWINGS

FIG. 1 is a schematic diagram of full channel/eigenvectors compression feedback.

FIG. 2 illustrates of CSI-RS samples.

FIG. 3 illustrates schematic diagram of an AI based CSI compression feature enabled feedback process.

FIG. 4 is a schematic diagram of an AI based CSI compression and CSI prediction feature enabled feedback process.

FIG. 5 is a schematic diagram of an AI based CSI prediction feature enabled feedback process.

FIG. 6 is a block diagram of a system architecture.

### DETAILED DESCRIPTION OF THE IMPLEMENTATIONS

### Introduction

The CSI feedback of the 5G NR system did not adopt full channel feedback, due to the high cost of full channel feedback. If AI can greatly reduce the cost of feedback after compression, it is possible to perform AI based full channel feedback in 5G-A systems.

The transmission method, payload size, and format of CSI feedback can standardize. The design of AI models may vary, and the content of CSI compression feedback obtained after AI encoding may also vary. Due to the fact that the feedback between the AI encoder and AI decoder can be considered as internal information within the AI network, there may be no need to standardize the specific content represented by the feedback. Instead, it can be useful to standardize the payload size and format of the feedback, so that the base station can parse the corresponding bits of the feedback to get useful information.

A problem is how to assign CSI payload size in an AI-based CSI feedback framework.

The problem of the current CSI reporting framework is that there is a delay between the time to which the reported CSI relates and the time when the BS receives the CSI report. In 5G non-terrestrial networks for satellite communications, the delay can range from a few milliseconds to hundreds of milliseconds. Such a large delay can cause the CSI to become outdated. In terrestrial networks where the delay is not large, a wireless channel can vary rapidly due to, e.g., high UE mobility, which can also cause the CSI to become outdated. CSI prediction reporting using, e.g., AI/ML algorithms, is one approach to mitigating the effect of the outdated CSI in the CSI reporting framework. In addition, CSI prediction can help reduce reference signal overhead and measurement reporting overhead. A problem is determining in which situation to enable AI based prediction feature.

Unlike AI/ML based CSI compression where a two-sided structure (CSI encoder at UE and CSI decoder at gNB) is employed, a one-sided structure is sufficient for AI/ML based CSI prediction. The AI/ML inference of a one-sided model can be performed at either gNB or the UE. One problem is determining in which side to perform AI based CSI prediction model.

There are several components of CSI in NR. CSI components in NR include, for example, CQI (Channel Quality Information), PMI (Precoding Matrix Indicator), LI (Layer Indicator) n and RI (Rank Indicator).

There are two types of codebook defined in the 5G system. Type I uses a number of predefined matrices which is selected by the UE report and RRC Configuration. A Type II codebook is not based on predefined table, it is based on a specifically designed methodical formula with many parameters. Those parameters in the formula are determined by the RRC and UE report. When using Type II codebook-based CSI feedback, the PMI feedback overhead can reach up to hundreds of bits, while RI feedback requires up to 3 bits. The use of AI models for compressed feedback on PMI has potential for reducing overhead. The compression of RI overhead has no room for enhancement, and there is no need to use AI models for compressed feedback on RI. At this point, it is possible to consider using AI models for compressed feedback on PMI, while RI uses traditional feedback methods.

### Disclosure

Reference is made to Third Generation Partnership Project (3GPP) and the Internet Engineering Task Force (IETF) in accordance with embodiments of the present disclosure. The present disclosure employs abbreviations, terms and technology defined in accord with Third Generation Partnership Project (3GPP) and/or Internet Engineering Task Force (IETF) technology standards and papers, including the following standards and definitions. 3GPP and IETF technical specifications (TS), standards (including proposed standards), technical reports (TR) and other papers are incorporated by reference in their entirety hereby, define the related terms and architecture reference models that follow.

### 3GPP TR 38.843 V0.1.0

### Acronyms

3GPP: Third generation partnership project
BS: Base Station
CAPEX: Capital Expenditure
COTS: Commercial off-the-shelf
C-plane: Control plane
C-RAN: cloud radio access network
CU: Central unit
DL: downlink
DU: Distribution unit
gNB: g NodeB (applies to NR)
MIMO: multiple input, multiple output
O-DU: O-RAN Distributed Unit
O-RU: O-RAN Radio Unit
O-RAN: Open RAN (Basic O-RAN specifications are prepared by the O-RAN alliance)
OPEX: Operating Expense
RLC: Radio Link Control
RU: Radio Unit
U-plane: User plane
UE: user equipment
UL: uplink
AI: Artificial Intelligence
ML: Machine Learning
CSI: Channel State Information
DCI: Downlink Control Information
RSRP: Reference Signal Receiving Power
SINR: Signal to Interference plus Noise Ratio
PUSCH: Physical Uplink Shared Channel
GCS: Generalized Cosine Similarity
SGCS: Square Generalized Cosine Similarity

### Definitions

Channel: the contiguous frequency range between lower and upper frequency limits.

C-plane: Control Plane: refers specifically to real-time control between O-DU and O-RU, and should not be confused with the UE's control plane.

DL: DownLink: data flow towards the radiating antenna (generally on the LLS interface).

LLS: Lower Layer Split: logical interface between O-DU and O-RU when using a lower layer (intra-PHY based) functional split.

0-CU: O-RAN Control Unit—a logical node hosting PDCP, RRC, SDAP and other control functions.

O-DU: O-RAN Distributed Unit: a logical node hosting RLC/MAC/High-PHY layers based on a lower layer functional split.

O-RU: O-RAN Radio Unit: a logical node hosting Low-PHY layer and RF processing based on a lower layer functional split. This is similar to 3GPP's “TRP” or “RRH” but more specific in including the Low-PHY layer (FFT/iFFT, PRACH extraction).

### OTA: Over the Air

U-Plane: User Plane: refers to IQ sample data transferred between O-DU and O-RU

UL: UpLink: data flow away from the radiating antenna (generally on the LLS interface)

The present disclosure provides embodiments of systems, devices and methods for Radio Access Networks and Cloud Radio Access Networks.

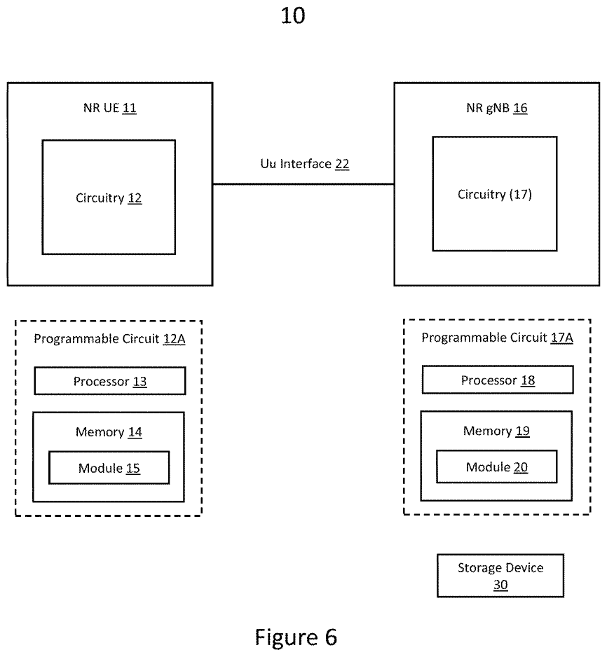

FIG. 6 is a block diagram of a system 10 environment implementing CSI compression and implementing an autoencoder structure via an exchange between a UE and a gNB. System 10 includes a NR UE 11, a NR gNB 16. The NR UE and NR gNB are communicatively coupled via a Uu interface 22.

NR UE 11 includes electronic circuitry, namely circuitry 12, that performs operations on behalf of NR UE 11 to execute methods described herein. Circuity 12 can be implemented with any or all of (a) discrete electronic components, (b) firmware, and (c) a programmable circuit 12A.

NR gNB 16 includes electronic circuitry, namely circuitry 17, that performs operations on behalf of NR gNB 16 to execute methods described herein. Circuity 17 can be implemented with any or all of (a) discrete electronic components, (b) firmware, and (c) a programmable circuit 17A.

Programmable circuit 17A, which is an optional implementation of circuitry 17, includes a processor 18 and a memory 19. Processor 18 is an electronic device configured of logic circuitry that responds to and executes instructions. Memory 19 is a tangible, non-transitory, computer-readable storage device encoded with a computer program. In this regard, memory 19 stores data and instructions, i.e., program code, that are readable and executable by processor 18 for controlling operations of processor 18. Memory 19 can be implemented in a random-access memory (RAM), a hard drive, a read only memory (ROM), or a combination thereof. One of the components of memory 19 is a program module, namely module 20. Module 20 contains instructions for controlling processor 18 to execute operations described herein on behalf of NR gNB 16.

The term “module” is used herein to denote a functional operation that may be embodied either as a stand-alone component or as an integrated configuration of a plurality of subordinate components. Thus, each of module 105 and 110 may be implemented as a single module or as a plurality of modules that operate in cooperation with one another.

While modules 20 are indicated as being already loaded into memories 19, and module 120 may be configured on a storage device 130 for subsequent loading into their memories 109. Storage device 30 is a tangible, non-transitory, computer-readable storage device that stores module 20 thereon. Examples of storage device 30 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled to NR gNB 106 via a data communications network.

Uu Interface 22 is the radio link between the NR UE and NR gNB, which is compliant to the 5G NR specification.

The 3rd Generation Partnership Project (3GPP) started the plan for 5G-Advanced and approved the package including 27 work items in Release 18. Release 18 is expected to pave the way toward integrating AI and communications.

In Massive MIMO systems, accurate channel state information (CSI) is required for downlink beamforming, user selection, and antenna selection. In Time Division Duplex (TDD) mode, the downlink CSI can be obtained from the uplink CSI by utilizing channel reciprocity; In Frequency Division Duplex (FDD) mode, the reciprocity between the uplink and downlink channels is weak, and the downlink CSI should be estimated and fed back to the base station (BS, Base Station) by the user. Downlink CSI acquisition contains two main steps. First, the user estimates the downlink CSI utilizing the received pilot signals transmitted by the BS. Then, the user feeds the estimated downlink CSI back to the BS through the uplink control channel. Vector quantization or codebook-based approaches are usually adopted to reduce feedback overhead. In massive MIMO systems, a large number of antennas at the BS result in a vast CSI dimension and require substantial feedback overhead. In addition, commercial deployments in 5G have observed that the user often experiences considerable performance loss due to the outdated CSI feedback by the user. Conventional CSI feedback methods cannot meet the requirement of low complexity and high accuracy.

Machine learning (ML) has been proposed for CSI feedback. In sharp contrast to the traditional approach, the ML approach exploits massive data retrieved from the network without explicitly deriving a mathematical model to compress CSI.

This disclosure is related to an AI/ML based CSI feedback enhancement in 5G system.

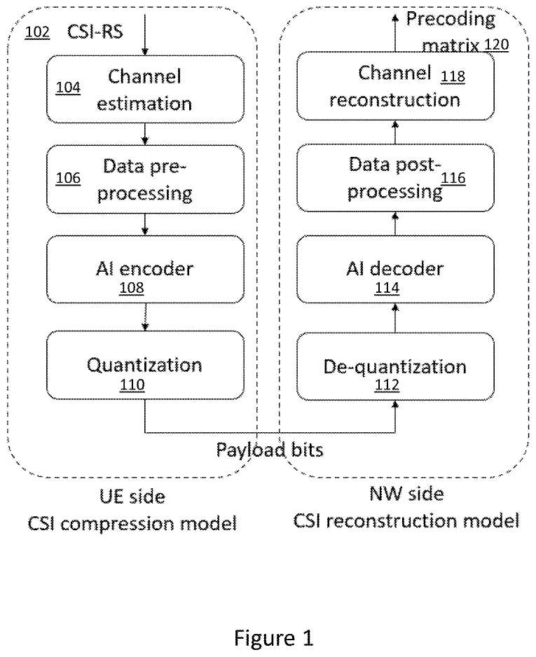

A schematic diagram of full channel/channel eigenvectors compression feedback based on AI is shown in FIG. 1. In an implementation, the dashed box in the figure can be an optional module. When performing full channel compression based on AI, an input of an AI encoder 108 is the channel estimation value 104 obtained by the user through the channel state information reference signal (CSI-RS) 102 or, a pre-processed channel information 106 including channel estimation value and channel eigenvectors. The channel information 106 is compressed and quantized 110 by the AI encoder 108 and fed back to a base station. The base station performs an inverse process to recover the channel information. The base station receives and dequantizes 112 the compressed information, which is the decoded by the AI decoder 114. The decoder is output to a post processing module 116 to output the channel estimation value for channel reconstruction 118 to a precoding matrix 120. The purpose of preprocessing the channel estimation values obtained by the user is to reduce the dimensionality of the AI encoder input, thereby reducing the complexity of AI model. Channel preprocessing is usually based on the sparsity of the channel in the time/spatial/frequency domain. In the design of some AI decoders, the quantization value fed back by CSI is directly used as input to the AI decoder, and there is no need for de-quantization steps at this time. When quantifying CSI feedback in the design of AI encoders, there is no longer a need for independent quantization modules outside of the AI encoder.

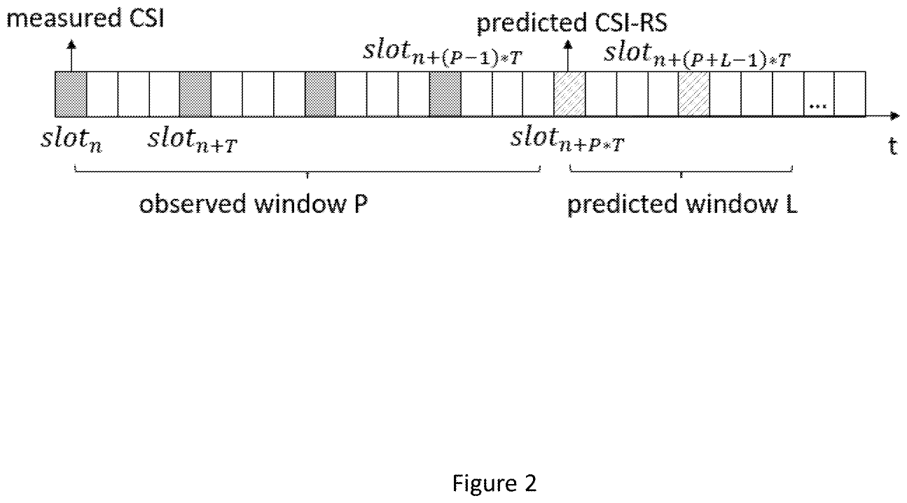

As shown in FIG. 2, an observed window P of historic measured CSI with long periodicity can be used as the input of CSI prediction model, the model output L future CSI. Regarding the input of AI model for CSI prediction, both raw channel matrixes and eigenvectors can be used.

In order to better present the AI based CSI feedback framework. AI related terminologies based on 3GPP [1] are presented in Table 1.

TABLE 1
list of terminologies

| Terminology | Description |
|---|---|
| AI/ML Model | A data driven algorithm that applies AI/ML |
| | techniques to generate a set of outputs |
| | based on a set of inputs. |
| AI/ML model training | A process to train an AI/ML Model [by |
| | learning the input/output relationship] in a |
| | data driven manner and obtain the trained |
| | AI/ML Model for inference. |
| AI/ML model Inference | A process of using a trained AI/ML model to |
| | produce a set of outputs based on a set of |
| | inputs. |
| AI/ML model validation | A subprocess of training, to evaluate the |
| | quality of an AI/ML model using a dataset |
| | different from one used for model training, |
| | that helps selecting model parameters that |
| | generalize beyond the dataset used for |
| | model training. |
| AI/ML model testing | A subprocess of training, to evaluate the |
| | performance of a final AI/ML model using a |
| | dataset different from one used for model |
| | training and validation. Differently from |
| | AI/ML model validation, testing does not |
| | assume subsequent tuning of the model. |
| UE-side (AI/ML) model | An AI/ML Model whose inference is |
| | performed entirely at the UE. |
| Network-side (AI/ML) | An AI/ML Model whose inference is |
| model | performed entirely at the network. |
| One-sided (AI/ML) | A UE-side (AI/ML) model or a Network- |
| model | side (AI/ML) model. |
| Two-sided (AI/ML) | A paired AI/ML Model(s) over which joint |
| model | inference is performed, where joint |
| | inference comprises AI/ML Inference |
| | whose inference is performed jointly across |
| | the UE and the network, i.e, the first part of |
| | inference is firstly performed by UE and |
| | then the remaining part is performed by |
| | gNB, or vice versa. |
| AI/ML model transfer | Delivery of an AI/ML model over the air |
| | interface, either parameters of a model |
| | structure known at the receiving end or a |
| | new model with parameters. Delivery may |
| | contain a full model or a partial model. |

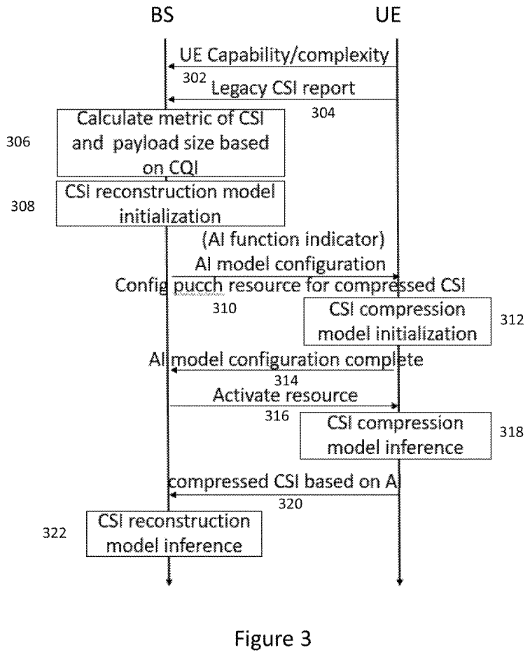

FIG. 3 shows a schematic diagram of an AI based CSI compression feature enable feedback process.
(1) At block 302, the UE reports UE complexity/capability to the base station, including FLOPs (Floating Point Operations Per Second), storage space, number of AI model parameters, and a supported AI model backbone (such as CNN, RNN, Transformer, ResNet).
(2) At block 304, the UE sends and the base station collects legacy CSI and at block 306, the base station calculates metrics of historic CSI to evaluate the correlation between them and calculate CSI payload size based on reported CQI. An exemplary correlation calculation can be, for example,

$$GCS = \frac{‖ {\tilde{w}}^{H} w ‖}{‖ \tilde{w} ‖ ‖ w ‖}$$

The base station determines whether to activate a CSI prediction feature by comparing the metrics with threshold #A. If the metrics such as correlation between historic CSI is smaller than the threshold #A, the base station can choose to use CSI prediction.
(3) If AI based CSI compression is activated, at block 308, the base station will select a trained AI model compatible with UE capability and initialize the CSI recovery part of AI model. At block 310, the base station then transfers the CSI compression part of AI model to UE which includes AI function indicators, AI model configuration information, and PUCCH resource configuration information. The AI function indicator contains 2 bits, the formatting of the AI function is shown in Table 2. The AI model configuration information includes the AI model parameter configuration, where the CSI payload size is determined by the previously reported CQI. There are two options for AI model configuration information:
Option1: Information includes a basic structure and main parameters of the AI model;
Option2: The AI model can be a “black box”, for example, an executable program.

When the relevant information of the AI model is the backbone and main parameters of the AI model, the UE side needs to construct the corresponding AI model based on this information. When the relevant information of the AI model is a “black box”, the opposite side does not need to know what the AI model is, but only needs input which meets the predetermined format to output the required information. The input of AI based CSI compression model can be the estimated raw channel(s) or eigenvector(s).

The payload size can be determined by a predefined table with CQI or can be calculated through a formula which contains a CQI parameter value.

TABLE 2
AI model indicator format.

| Feature indicator name | value |
|---|---|
| CSI compression | 1 represent enable |
| | 0 represent disable |
| CSI prediction | 1 represent enable |
| | 0 represent disable |

TABLE 3
CQI vs payload size

| CQI | AI based CSI feedback payload size |
|---|---|
| 0 | Payload #A1 |
| . . . | . . . |
| 15 | Payload #A15 |

1) At block 312, the UE initializes the CSI compression part of AI model based on the received model configuration information.
2) At block 314, after the initialization of the UE side model is completed, UE reports the configuration completed confirmation to the base station.
3) After receiving the UE confirmation message, at block 316, the base station sends the activation PUCCH resource command to allocate resource for an AI based CSI report.
4) At block 318, the UE executes the CSI compression model inference and at block 320, sends AI based compressed CSI.
5) At block 322, the base station reconstructs the model inference.

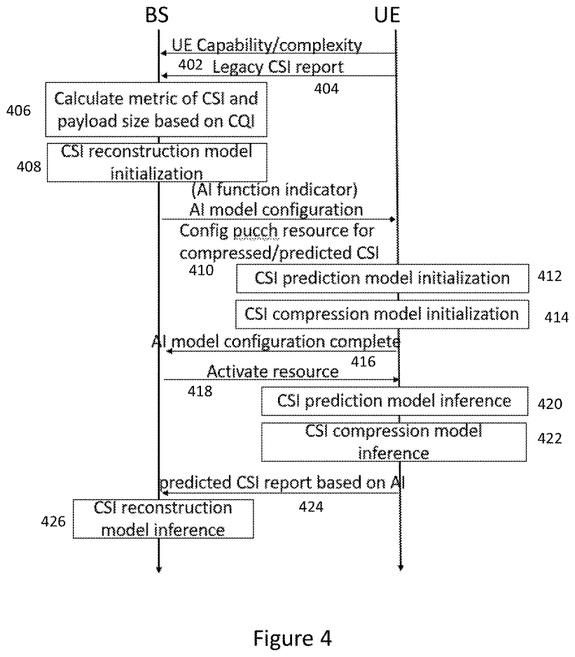

FIG. 4 shows the schematic diagram of a potential an AI based CSI compression and CSI prediction feature enable CSI feedback process.
1) At block 402, UE reports UE complexity/capability to the base station, including FLOP (Floating Point Operations Per Second), storage space, number of AI model parameters, and a supported AI model backbone (such as CNN, RNN, Transformer, ResNet). At block 404, the base station calculates metrics of historic CSI to evaluate the correlation between them and calculate CSI payload size based on reported CQI as described above with respect to FIG. 3.
2) The base station determines whether to activate CSI prediction feature by comparing the metrics with threshold #A. If the metrics such as correlation between historic CSI is smaller than the threshold #A, the base station can choose to use CSI prediction.
3) At block 408, if AI based CSI compression and CSI prediction both are activated, the base station will select a trained AI model compatible with UE capability and initialize the CSI recovery part of AI model. At block 410, the base station then transfers the CSI compression part of AI model and AI based CSI prediction model to UE, which includes AI function indicators, AI model configuration information, and pucch resource configuration information. The AI function indicator contains 2 bits. Table 2 above shows the format of the AI function indicator. AI model configuration information includes the AI model parameter configuration, where the CSI payload size is determined by the previously reported CQI. The pucch resource configuration for the compressed CSI and/or predicted CSI is as follows:

In Table 4, the CSI-ReportConfig, compressed CSI and/or predicted CSI is added as shown in bold emphasis:

TABLE 4
CSI-ReportConfig

```
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, -- Need R
  nzp-CSI-RS-ResourcesForInterference CSI-ResourceConfigId OPTIONAL, --
Need R
  reportConfigType CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-
CSI-Resource
      pucch-compressed/predictedCSI-ResourceList SEQUENCE (SIZE
(1..maxNrofBWPs)) OF PUCCH-compressed/predictedCSI-Resource
    },
    semiPersistentOnPUCCH SEQUENCE {
      reportSlotConfig CSI-ReportPeriodicityAndOffset,
      pucch-CSI-ResourceList SEQUENCE (SIZE (1..maxNrofBWPs)) OF PUCCH-
CSI-Resource
      pucch-compressed/predictedCSI-ResourceList SEQUENCE (SIZE
(1..maxNrofBWPs)) OF PUCCH-compressed/predictedCSI-Resource
    },
    semiPersistentOnPUSCH SEQUENCE {
      reportSlotConfig ENUMERATED {sl5, sl10, sl20, sl40, sl80, sl160, sl320},
      reportSlotOffsetList SEQUENCE (SIZE (1..maxNrofUL-Allocations)) OF
INTEGER(0..32),
      p0alpha P0-PUSCH-AlphaSetId
    },
    aperiodic SEQUENCE {
      reportSlotOffsetList SEQUENCE (SIZE (1..maxNrofUL-Allocations)) OF
INTEGER(0..32)
    }
}
...
...
PUCCH-CSI-Resource ::= SEQUENCE {
  uplinkBandwidthPartId BWP-Id,
pucch-Resource PUCCH-ResourceId
PUCCH-compressed/predictedCSI-Resource ::= SEQUENCE {
  uplinkBandwidthPartId BWP-Id,
pucch-Resource  PUCCH-ResourceId
}
```

4) At block 412, UE initializes the CSI prediction model and at block 414 the UE initializes the CSI compression part of AI model based on the received model configuration information.
5) After the initialization of the UE side model is completed, at block 416 UE reports the configuration completed confirmation to the base station.
6) At block 418, after receiving the UE confirmation message, the base station sends the activation pucch resource command to allocate resource to AI based CSI report.
7) At block 420, the UE first uses a trained AI based CSI prediction model to predict future CSI, and at block 422, the UE then compresses the predicted CSI. At block 424, the UE reports the AI predicted CSI to the base station. At block 426, the base station reconstructs the model inference.

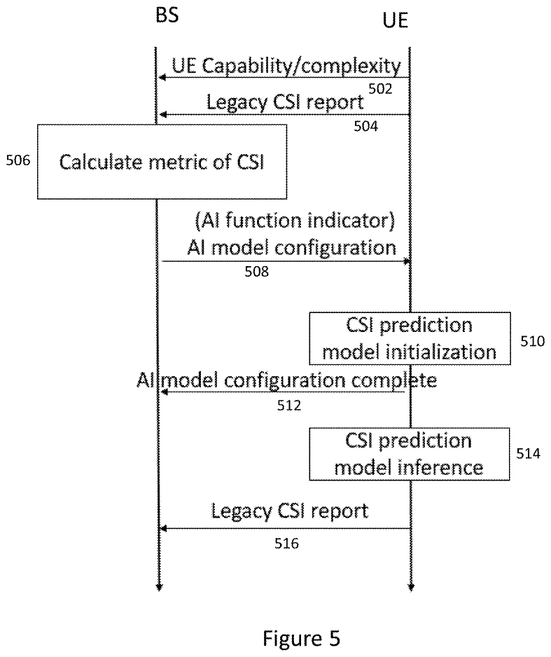

FIG. 5 shows the schematic diagram of a potential AI based CSI prediction feature enable feedback process. In this case,
1) At block 502, UE reports UE complexity/capability to the base station, including FLOP (Floating Point Operations Per Second), storage space, number of AI model parameters, and supported AI model backbone (such as CNN, RNN, Transformer, ResNet).
2) At block 504, the base station collects legacy CSI and at block 506 the base station calculates metrics of historic CSI to evaluate the correlation between them and calculate CSI payload size based on reported CQI as described above with respect to FIG. 3. The base station determines whether to activate CSI prediction feature by comparing the metrics with threshold #A. If the metrics such as the correlation between historic CSI is smaller than the threshold #A, the base station can choose to use CSI prediction.
3) If only AI based CSI prediction is activated, at block 508, the base station then transfers the AI based CSI prediction model to UE, which includes AI function indicators, AI model configuration information.
4) At block 510, the UE initializes the CSI prediction model based on the received model configuration information.
5) At block 512, after the initialization of the UE side model is completed, UE reports the configuration completed confirmation to the base station.
6) At block 514, the UE side uses AI based CSI prediction model inference and outputs predicted CSI based on measured CSI. At block 516, the UE reports predicted CSI in legacy way e.g.: the Rel-16/17/18 Type II codebook. The UE first thus predicts the future CSI based on CSI prediction model, and then reports predicted CSI through legacy PMI codebook.

It will be understood that implementations and embodiments can be implemented by computer program instructions. These program instructions can be provided to a processor to produce a machine, such that the instructions, which execute on the processor, create means for implementing the actions specified herein. The computer program instructions can be executed by a processor to cause a series of operational steps to be performed by the processor to produce a computer-implemented process such that the instructions, which execute on the processor to provide steps for implementing the actions specified. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the disclosure.

1. A method comprising:
reporting, by a user equipment (UE), a UE capability to a base station, the UE capability comprising: a supported AI model and a number of AI model parameters;
collecting, by the Base Station (BS), a legacy CSI report and calculating a metric of a historic CSI for an observed window P to evaluate the correlation between the historic CSI;
determining, by the BS, whether to activate a CSI prediction feature by comparing the metric with a threshold, and, if the correlation between the historic CSI for the observed window P choosing to use CSI prediction;
if an AI based CSI compression, AI based CSI prediction feature, or both are activated, selecting, by the BS, a trained AI model compatible with the UE capability and initialize a CSI recovery part of AI model; and
transferring, by the BS and the trained AI model to the UE, a CSI compression part, the CSI prediction feature, or both, of the AI model.

2. The method of claim 1, wherein the AI model comprises: AI function indicators, AI model configuration information, and the AI model configuration information includes the AI model parameter configuration.

3. The method of claim 2, comprising:
the AI model configuration information comprising a structure and parameters or an executable program.

4. The method of claim 3, further comprising:
constructing, by the UE, a corresponding AI model based on the structure and parameters sent from BS based on input which meets the predetermined format, the input being selected an estimated raw channel or and eigenvector.

5. The method of claim 1, further comprising a CSI payload size is determined by a reported CQI of the historic CSI, and wherein the payload size is determined by a predefined table with CQI or a formula which contains a CQI parameter value.

6. The method of claim 1, wherein the UE initializes the CSI compression part, the CSI prediction feature, or both, of AI model based on the received model configuration information.

7. The method of claim 6, wherein, after the UE initialization of the AI model, the UE sends a completed configuration confirmation to the BS.

8. The method of claim 7, wherein the AI model comprises PUCCH resource configuration information, and the method further comprises: after the BS receives the UE confirmation message, the BS sends an activation PUCCH resource command to allocate a resource for an AI based CSI report.

9. The method of claim 6, wherein
the UE, is using a trained CSI prediction model of the AI model to predict a future CSI.

10. The method of claim 7, wherein
the UE, is compressing the predicted future CSI for a report to the BS or
is reporting the predicted CSI through a legacy PMI codebook.

11. The method of claim 1, wherein the UE capability comprises: FLOPs (Floating Point Operations Per Second), and storage space.

12. The method of claim 1, wherein the AI model is selected from the group of a CNN, a RNN, a Transformer model, and/or a ResNet model.

13. The method of claim 1, wherein the threshold is
$$GCS = \frac{‖ {\tilde{w}}^{H} w ‖}{‖ \tilde{w} ‖ ‖ w ‖} .$$

14. The method of claim 13, wherein the threshold is in the value range of from about 0.6 to about 0.8.
